(19) United States
(12) Patent Application Publication
(10) Pub. No.: US 2006/0240266 A1
(43) Pub. Date: Oct. 26, 2006

(54) Transparent substrate comprising a coating with mechanical strength properties

(75) Inventors: Heinz Schicht, Torgau (DE); Valerie Coustet, Aubervilliers (FR); Nicolas Nadaud, Aubvervilliers (FR); Sylvain Belliot, Aubervilliers (FR)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: SAINT-GOBAIN GLASS FRANCE, Courbevoie (FR)

(21) Appl. No.: 10/562,222

(22) PCT Filed: Jun. 25, 2004
(86) PCT No.: PCT/FR04/01621

§ 371 Date: Jun. 19, 2006

(30) Foreign Application Priority Data
Jun. 26, 2003 (FR) 03/07750

(51) Int. Cl. B32B 17/06; B32B 9/00; B05D 5/06

(52) U.S. Cl. 428/426; 428/698; 428/432; 428/701; 428/702; 428/469; 427/162

(57) ABSTRACT

The invention relates to a transparent substrate, especially of the glass type, which comprises a coating that contains at least one layer C based on silicon or aluminum [nitride, carbonitride, oxynitride or oxycarbonitride] or on a mixture of the two, which is surmounted by a cover layer, characterized in that the cover layer is an oxide-base mechanical protection layer, this oxide being optionally oxygen-substoichiometric or oxygen-superstoichiometric and/or optionally nitrided. Application to the production of a glazing assembly, especially a multiple or laminated glazing assembly.

The present invention relates to the field of transparent multilayer-coated substrates exhibiting an optical effect and/or an effect on high-energy radiation.

More particularly, the invention relates to multilayers that include a layer based on silicon nitride exhibiting an antireflection property and possibly contributing to protecting the subjacent layers from deteriorating due to a heat treatment or to the multilayer-coated substrate's conversion process.

Multilayers on a glass substrate are known, these including a functional layer, especially a metal layer, such as a silver layer, and one or more nitride-based layers, especially made of silicon nitride or aluminum nitride or a mixture of the two, which give the multilayers a high resistance to heat treatment of the type for toughening, bending or assembling a laminated glass pane. Mention may be made of documents EP 718 250, EP 847 965 and EP 995 715 which describe multilayers using a metal functional layer, of the silver type, or document WO-01/21540 which describes multilayers using a functional layer based on another metal or on a metal nitride.

Silicon nitride appears as material of choice for forming a protective layer for protecting against corrosive species encountered during a heat treatment, and for maintaining acceptable optical properties of the multilayer after treatment.

However, defects may also be encountered when these multilayers are subjected to a conversion operation with heat treatment under industrial conditions. It seems that these defects are due, in certain cases, to a defect of a physical nature of the multilayer, such as a crack, which favors penetration of the corrosive species into the multilayer: even a fine scratch before heat treatment may be transformed after treatment into a defect whose size or appearance is unacceptable owing to the development of corrosion during the heating.

The lack of scratch resistance of silicon nitride, due partly to a high friction coefficient, is known, for example from document WO-A-00/69784 which proposes to remedy this by depositing the silicon nitride in the presence of carbon so as to produce a mixed silicon nitride/silicon carbide coating in one and the same layer.

This solution is not, however, completely satisfactory insofar as it modifies the intrinsic properties of the material and, in particular, prejudices its optical properties.

Various materials are known for their mechanical resistance and are employed in the field of coated substrates as a top layer or cover layer with a mechanical protection function.

Patent applications EP 183 052 and EP 226 993 disclose transparent multilayers of low emissivity, in which a functional metal layer, in particular a thin silver layer, is placed between two dielectric antireflection layers that are produced by the oxidation of a zinc/tin alloy. These dielectric layers are deposited by magnetically enhanced reactive sputtering using a reactive gas containing oxygen, from a metal target composed of a Zn/Sn alloy. The mixed oxide layer contains a relatively large amount of zinc stannate, which gives the layer particularly favorable properties, most especially in terms of mechanical and chemical stability. However, sputtering from targets made of a ZnSn alloy poses certain technical difficulties.

According to document WO-A-00/24686, the sputtering is facilitated because the target contains zinc, tin and at least one additional element taken from Al, Ga, In, B, Y, La, Ge, Si, P, As, Sb, Ce, Ti, Zr, Nb and Ta. A considerable improvement in the layer properties, especially chemical and mechanical durability, and in optical quality is also obtained. This composite layer may be used because of its chemical and mechanical durability especially as top cover layer associated with at least one subjacent or superjacent contiguous oxide layer.

Document WO-99/05072 describes a glass substrate provided with a multilayer that can undergo a heat treatment of the bending and/or toughening type, which includes a thin layer based on silicon [nitride, carbonitride, oxynitride and/or oxycarbonitride] (hereafter denoted by the term “silicon nitride layer”). This layer is surmounted by a protective layer that protects against high-temperature corrosion by species of the Na₂O, chloride or sulfide type, which protective layer may be a metal layer or an oxygen-substoichiometric metal oxide layer intended to be completely oxidized during the heat treatment, with substantial changes in optical properties, or else a metal oxide, oxycarbide and/or oxynitride layer that does not undergo conversion during the heat treatment, with no change in optical properties. The metal may be chosen from Nb, Sn, Ta, Ti and Zr, with a preference for Nb.

In practice, only a final niobium layer is described, and a laminated-glass bending/assembly heat treatment is accompanied by an increase in light transmission owing to oxidation of the niobium with formation of a compound with sodium. One drawback is the large optical change due to the heat treatment, which makes the process complicated, increases the time needed to implement it and increases the manufacturing costs.

The object of the invention is to provide a substrate, in particular for glazing, which comprises a multilayer system that includes at least one layer based on silicon nitride (within the meaning explained above), having improved mechanical resistance properties.

The substrate according to the invention is defined in claim 1. This substrate, especially a glass substrate, is provided with a coating that includes at least one layer C based on:
silicon nitride, silicon carbonitride, silicon oxynitride or silicon oycarbonitride; or
aluminum nitride, aluminum carbonitride, aluminum oxynitride or aluminum oxycarbonitride; or else
a mixed silicon aluminum nitride, a mixed silicon aluminum carbonitride, a mixed silicon aluminum oxynitride or a mixed silicon aluminum oxycarbonitride, this layer C being surmounted by a cover layer which is an oxide-based mechanical protection layer, this oxide being optionally oxygen-substoichiometric or oxygen-superstoichiometric and/or optionally nitrided.

It seems that the combination of a hard layer C of silicon nitride (within the meaning of the present invention) with a final top oxide layer makes it possible to achieve remarkable mechanical resistance, probably because the lubricating properties of the oxide limit the fracture of the subjacent multilayer when said layer is mechanically stressed. This results in improved resistance to both indentation and abrasion, and also improved resistance to damage by inter-layer shearing.

The oxides are also advantageous as layers used in the composition of a glazing assembly because of their transparency and their optical properties in general, which do not change the optical character of the glass product.

The protective oxide layer advantageously contains at least one element chosen from Ti, Zn, Sn, Al, Ga, In, B, Y, La, Ge, Si, P, As, Sb, Bi, Ce, Ti, Zr, Nb, Ta and Hf and preferably from Ti, Zn, Sn and Zr.

The oxide layer may be based on a single oxide or a mixture of oxides, or it may itself consist of a superposition of several oxide layers and/or several mixed oxide layers.

Among the oxides that can be used in the composition of the mechanical protection cover layer, mention may be made of:

a) an optionally oxygen-substoichiometric or oxygen-superstoichiometric and/or optionally nitrided titanium oxide, optionally containing another metal M such as aluminum (compounds of formula TiMₚOₓN_{y} where p and y may be zero and x may be less than, equal to or greater than 2).

Among titanium-based oxides, it is advantageous to use TiO₂, TiOₓ where 1≦x≦2, and TiOₓN_{y} where 1≦x≦2 and 0.5≦y≦1.

Among these compounds, nitrided titanium oxide TiOₓN_{y} proved to be superior to TiO₂ from the standpoint of scratch resistance.

These compounds can be deposited on a silicon nitride layer by sputtering from TiOₓ substoichiometric oxide targets in an inert, oxidizing and/or nitriding atmosphere, or from Ti targets in an oxidizing and/or nitriding atmosphere;

b) an oxide containing at least zinc and optionally at least one other element, optionally doped by at least one other element chosen from Al, Ga, In, B, Y, La, Ge, Si, P, As, Sb, Ce, Ti, Zr, Nb, Hf and Ta, this oxide being optionally oxygen-substoichiometric or oxygen-superstoichiometric and/or optionally nitrided. Such an oxide may especially be a mixed oxide based on zinc and another metal, especially based on zinc and tin (ZnSnOₓ) or zinc and titanium (ZnTiOₓ) or zinc and zirconium (ZnZrOₓ), optionally doped, in particular by Al or Sb.

Among mixed zinc tin oxides, it is preferred to use ternary oxides containing one or more addition elements from Al, Ga, In, B, Y, La, Ge, Si, P, As, Sb, Bi, Ce, Ti, Zr, Nb, Ta and Hf, for example in an amount from 0.5 to 6.5% by weight, as described in WO-00/24686. Although these oxides are known to have a high mechanical stability, their “lubricating” effect (in fact a lowering of the friction coefficient due to a reduction in roughness) on a silicon nitride layer has been demonstrated by the inventors and put to good use in the claimed multilayers.

In general, mixed oxides with a spinel structure may advantageously be used according to the invention, such as those of the ZnᵣSnₛSbₜOₓ, ZnᵣSnₛAlᵤOₓ and ZnᵣTi_{z}AlᵤOₓ type; and

c) an oxide containing at least zirconium, and optionally at least one other element, especially a mixed oxide based on Zr, optionally containing another metal and optionally doped by at least one other element chosen from Al, Ga, In, B, Y, La, Ge, Si, P, As, Sb, Ce, Ti, Zn, Nb, Hf and Ta, this oxide being optionally oxygen-substoichiometric or oxygen-superstoichiometric and/or optionally nitrided.

It is also possible to use, for forming the mechanical protection cover layer, a superposition of layers of the aforementioned oxides, such as especially a combination of ZnO/TiO₂, ZnᵣSnₛSbₜOₓ/TiO₂, ZnᵣSnₛAlᵤOₓ/TiO₂ and ZnᵣZrᵥOₓ/TiO₂ layers.

The oxide layer does not have to be very thick to provide abrasion resistance. Thus, the thickness of this layer may be around 15 nm or less, advantageously 10 nm or less.

The layer(s) C of silicon nitride (within the meaning of the present invention) may furthermore contain at least one other metal element such as aluminum.

The improvement in scratch resistance is observed even if the thickness of the layer C is relatively high. Thus, the thickness of this layer may be around 5 to 60 nm, preferably 10 to 40 nm.

According to one feature, the coating includes at least one functional layer, based on a metal or metal nitride.

The protected multilayer system according to the invention may provide any type of function, for example a simple antireflection function, but preferably a solar-control function or energy-control function of the low-emissivity type using at least one functional layer, especially a metal layer, that reflects some of the radiation of the solar spectrum. The protective layer according to the invention does not appreciably impair the optical properties of the system, nor its resistance to toughening or bending.

Such a protected multilayer system according to the invention may in general comprise the sequence: final oxide dielectric layer/silicon nitride/oxide, especially ZnO/Si₃N₄/ZnO (where Si₃N₄ may contain an additional element such as aluminum).

Advantageously, the functional layer is based on silver and forms part of a multilayer having the following sequence: Si₃N₄/ZnO/Ag/ZnO/Si₃N₄ or Si₃N₄/ZnO/Ag/Si₃N₄/ZnO/Ag/ZnO/Si₃N₄. A “blocking” metal layer, such as Ti or NiCr, may also be inserted in contact with at least one of the functional silver layers, on top of and/or beneath said layers.

In particular, the invention is suitable for protecting a multilayer system intended to undergo a heat treatment, such as bending and/or toughening, but also for protecting a laminated assembly.

In this regard, a protective layer made of at least partly nitrided titanium oxide proves to be particularly advantageous as it does not cause the appearance of optical defects (pifting, haze, etc.) in the multilayer during the heat treatment, and without changing the optical behavior of the product after the treatment.

The subject of the invention is also a glazing assembly incorporating at least one substrate as described above, especially in a multiple glazing or laminated glazing configuration.

The following examples illustrate the invention.

### EXAMPLE 1

In this example, the protective properties of a protective titanium oxide layer on a silver-based multilayer system were evaluated, the system having the following structure:

Glass/Al:Si₃N₄/Al:ZnO/Ti/Ag/Al:ZnO/Al:Si₃N₄/Al:ZnO/Ti/Ag/Al:ZnO/Al:Si₃N₄, where Al:Si₃N₄ means that the nitride contains aluminum. The same applies in the case of Al:ZnO, which means that the oxide contains aluminum.

The following table gives the thicknesses in nanometers for each of the layers:

| | Thickness | |
|---|---|---|
| Al:Si₃N₄ | 22 | nm |
| Al:ZnO | 8 | nm |
| Ti | 0.5 | nm |
| Ag | 8.7 | nm |
| Al:ZnO | 6 | nm |
| Al:Si₃N₄ | 60 | nm |
| Al:ZnO | 10 | nm |
| Ti | 0.5 | nm |
| Ag | 10 | nm |
| Al:ZnO | 5 | nm |
| Al:Si₃N₄ | 25 | nm |

This multilayer was produced by a known sputtering technique on the substrate, which ran through a sputtering chamber past an aluminum-doped Si cathode in a nitrogen-containing atmosphere, then an aluminum-doped Zn cathode in an oxygen-containing atmosphere, then a titanium cathode and a silver cathode in an inert atmosphere, again a Zn cathode in an oxygen-containing atmosphere, respectively, and the sequence was repeated in order finally for the substrate to run past an Si target in a nitrogen-containing atmosphere.

The TiO₂ protective layer was deposited on the silicon nitride from a cathode made of substoichiometric titanium oxide (TiOₓ) in an oxygen-containing atmosphere, which ensured that it was converted into stoichiometric oxide. The conditions were chosen so that the TiO₂ thickness was 1 nm.

The properties of the multilayer were compared with a control multilayer of the structure indicated above in the following tests:
washing machine test (according to ASTM 2486): any impairment in the multilayer in the form of delamination at the silver layer propagating by blistering is observed. This test is representative of the shearing resistance of the multilayer system deposited on the substrate;
Erichsen scratch resistance test: a Bosch steel point of cylindrical shape with a 0.75 mm-diameter hemispherical tip, loaded with a weight, is moved over the substrate at a given speed. The number of passes needed for the point to visibly scratch the multilayer is noted.

The results are given in Table 1 below.

TABLE 1

| | | | Ex. 1: |
|---|---|---|---|
| | | Control: no protection | 1 nm TiO₂ protection |
| Washing | | Highly degraded layers | Hardly degraded layers |
| machine | | | |
| test | | | |
| ERICHSEN | 0.2N load | 1 pass | 9 passes |
| test | 0.5N load | 1 pass | 3 passes |

These results show that the TiO₂ overlayer very substantially improves the scratch resistance of the multilayer and its resistance to internal shearing. This is attributed to a lubricating effect of the silicon nitride by the titanium oxide.

A similar result is obtained with an overlayer deposited from a titanium metal target in an oxidizing atmosphere.

### EXAMPLE 2

This example relates to the protection of the multilayer described in Example 1, but with a nitrided titanium oxide TiOₓN_{y} layer.

As in Example 1, the protective layer was deposited on the silicon nitride from a cathode made of substoichiometric titanium oxide (TiOₓ) in a nitrogen-containing atmosphere. The deposition of the latter layer could if necessary be carried out in the same chamber, that is to say in the same atmosphere, as the silicon nitride deposition.

The deposition conditions were varied so that the TiOₓN_{y} thickness varied from 1 to 3 nm.

The resistance of the multilayer was evaluated by:
the washing machine test;
the Erichsen scratch resistance test, by indentation using a Bosch steel point of cylindrical shape with a 0.75 mm-diameter hemispherical tip, loaded with a weight; and
a Taber abrasion resistance test: in this test, the specimen is subjected to an abrasive disk for a given time and the % proportion of the area of the multilayer system not torn is evaluated.

The results are given in Table 2 below.

### EXAMPLE 3

In this example, the protective properties of a protective titanium oxynitride TiOₓN_{y} layer of a type different from that of Example 2 on a silver-based multilayer system of the structure specified in Example 1 were evaluated.

The difference between this example and Example 2 lies in the fact that the protective layer was deposited by sputtering from a substoichiometric TiOₓ target in an atmosphere containing nitrogen and oxygen.

The results are given in Table 2 below.

TABLE 2

| | | | Ex. 2 | | | Ex. 3 | | |
|---|---|---|---|---|---|---|---|---|
| | | Control | TiOₓN_{y} Protection | | | TiO₂:N Protection | | |
| Test | | — | 1 nm | 2 nm | 3 nm | 1 nm | 2 nm | 3 nm |
| Washing machine* | | 0 | 1 | 1 | 2 | 1 | 2 | 1 |
| TABER (%) | | 66 | 63 | 69 | 76 | 79 | 78 | 77 |
| ERICHSEN | 0.2 N | 1 | 12 | 10 | 9 | 6 | 5 | 5 |
| (passes) | load | | | | | | | |
| | 0.5 N | 1 | 3 | 5 | 4 | 3 | 3 | 2 |
| | load | | | | | | | |

*0 = highly degraded layers 1 = moderately degraded layers 2 = barely degraded layers

These results show that the two protective layers of Examples 2 and 3 substantially improve the scratch resistance and shearing resistance of the multilayers.

### EXAMPLE 4

In this example, a protective layer according to the invention was applied to a silver-based multilayer system in order to obtain the following structure:

Glass/Si₃N₄/ZnO/Ti/Ag/ZnO/Si₃N₄/ZnO/Ti/Ag/ZnO/Si₃N₄/TiO₂.

The substrate was a clear silica-soda-lime glass of the PLANILUX type sold by Saint-Gobain Glass.

The table below gives the thickness values of the various thin layers of the multilayer:

| | Thickness (nm) | |
|---|---|---|
| Si₃N₄ | 20 | |
| ZnO | 10 | |
| Ti | 1.5 | |
| Ag | 14 | |
| ZnO | 10 | |
| Si₃N₄ | 73 | |
| ZnO | 10 | |
| Ti | 1.5 | |
| Ag | 14 | |
| ZnO | 10 | |
| Si₃N₄ | 22.5 | |
| TiO₂ | 0.5 to 2 | nm |

In this example, the protective properties of a protective layer made of nitrided titanium oxide TiO₂ were evaluated. The protective TiO₂ layer was deposited on the silicon nitride from a cathode. made of substoichiometric titanium oxide TiOₓ in an atmosphere containing oxygen and nitrogen.

The deposition conditions were varied so that the TiO₂ thickness varied from 0.5 to 2 nm. In all cases, and even when the deposition atmosphere contained oxygen, no increase in the light transmission of the multilayer of greater than 0.5% over the control multilayer without a protective overlayer was observed.

The scratch resistance was evaluated by means of the Erichsen test, using a steel point of the Van Laar type, with a 0.5 mm-diameter spherical tip. The load needed for the appearance of a scratch visible to the naked eye was determined.

Furthermore, the substrate was subjected to a heat treatment at 620° C. for 8 minutes and the optical changes between the untreated state and the treated state were observed.

The results are given in Table 3 below.

### EXAMPLE 5

In this example, a protective layer according to the invention was applied to a silver-based multilayer system in order to obtain the following structure:

Glass/Si₃N₄/ZnO/Ti/Ag/ZnO/Si₃N₄/ZnO/Ti/Ag/ZnO/Si₃N₄/TiOₓN_{y}.

In this example, the protective properties of a protective layer made of nitrided titanium oxide TiOₓN_{y} were evaluated. The protective TiOₓN_{y} layer was deposited on the silicon nitride from a cathode made of substoichiometric titanium oxide TiOₓ in a nitrogen-containing atmosphere.

As in Example 4, the scratch resistance, obtained by means of the Erichsen test, and the toughening-induced optical changes are evaluated and the results are given in Table 3 below, in which the results obtained with a control product not containing a surface oxide layer also appear.

TABLE 3

| | Load for a | |
|---|---|---|
| Example | scratch to appear | Toughening-induced optical changes |
| 4 | 1.6 N | Slight haze - red |
| 5 | 3.5 N | No change in color |
| Control | 0.3 N | No change in color |

This shows that the protective layer according to the invention considerably increases the scratch resistance of the multilayer.

Moreover, the optical variations of the substrates of Example 5 remain limited and of the same order of magnitude as the control product, with a before toughening/after toughening change in calorimetric response in transmission ΔE(T) of about 3, a before toughening/after toughening change in colorimetric response in external reflection ΔE(Rₑₓₜ) of about 2.9 and a before toughening/after toughening change in colorimetric response in internal reflection ΔE(Rᵢₙₜ) of about 2.7. The substrate of Example 4 had a slight red haze after heating of the substrate.

It will be recalled that a change in colorimetric response ΔE is conventionally expressed, in the (L, a*,b*) system, in the following way: ΔE=(Δ^{*2}+Δa^{*2}+Δb^{*2})^{1/2}.

It is apparent that, in the case of the layers deposited in an atmosphere not containing oxygen, the optical quality after heating is good, with no defect appearing. In contrast, when the atmosphere for depositing the titanium oxide layer contains oxygen, a slight defect in the form of a colored haze then appears.

### EXAMPLE 6

In this example, the protective properties of a protective layer made of zirconium oxide ZrO₂ were evaluated in the following silver-based multilayer system:

Glass/Si₃N₄/ZnO/Ag/Ti/ZnO/Si₃N₄/ZrO₂.

The following table gives the thicknesses in nanometers for each of the layers:

| | Thickness | |
|---|---|---|
| Si₃N₄ | 25 | nm |
| ZnO | 10 | nm |
| Ag | 8.7 | nm |
| Ti | 0.5 | nm |
| ZnO | 21 | nm |
| Si₃N₄ | 21 | nm |
| ZrO₂ | 4 | nm |

As in Example 4, the scratch resistance, obtained by means of the Erichsen test, the abrasion resistance, obtained by means of the Taber test, and the toughening-induced optical changes were evaluated and the results are given in Table 4 below, in which the results obtained with a control product not containing a surface oxide layer also appear.

TABLE 4

| | Load for a | TABER (% | Toughening-induced | | |
|---|---|---|---|---|---|
| | scratch to | of coating | optical changes | | |
| Example | appear | not abraded) | ΔE(T) | ΔE(Rₑₓₜ) | ΔE(Rᵢₙₜ) |
| 6 | 2 N | 77 | 1.0 | 2.3 | 3.5 |
| Cont. | 0.1 N | 63 | 0.9 | 1.7 | 2.4 |

This shows that the scratch resistance is considerably increased with the ZrO₂ protective layer and the abrasion resistance is also improved, whereas the optical changes of the substrates of Example 6 remain limited and of the same order as the control product.

### EXAMPLE 7

In this example, the protective properties of a protective layer made of a mixed zinc tin oxide doped with antimony, ZnSnSbOₓ, were evaluated in the following silver-based multilayer system:

Glass/Si₃N₄/ZnO/Ag/Ti/ZnO/Si₃N₄/ZnSnSbOₓ.

The following table gives the thicknesses in nanometers for each of the layers:

| | Thickness | |
|---|---|---|
| Si₃N₄ | 25 | nm |
| ZnO | 10 | nm |
| Ag | 10 | nm |
| Ti | 0.5 | nm |
| ZnO | 21 | nm |
| Si₃N₄ | 21 | nm |
| ZnSnSbOₓ | 5 | nm |

As in Example 6, the scratch resistance, obtained by means of the Erichsen test, the abrasion resistance, obtained by means of the Taber test, and the toughening-induced optical changes were evaluated and the results are given in Table 5 below, in which the results obtained with a control product not containing a surface oxide layer also appear.

TABLE 5

| | Load for a | TABER (% | Toughening-induced | | |
|---|---|---|---|---|---|
| | scratch to | of coating | optical changes | | |
| Example | appear | not abraded) | ΔE(T) | ΔE(Rₑₓₜ) | ΔE(Rᵢₙₜ) |
| 7 | 4 N | 80 | 1.4 | 3.4 | 4.4 |
| Cont. | 0.1 N | 63 | 0.9 | 1.7 | 2.4 |

This shows that the scratch resistance is considerably increased with the ZnSnSbOₓ protective layer and the abrasion resistance is also improved, while the optical changes of the substrates of Example 7 remain generally acceptable.

The present invention has been described in the foregoing by way of example. Of course, a person skilled in the art is capable of producing various alternative embodiments of the invention without thereby departing from the scope of the patent as defined by the claims.

1. A transparent substrate, especially of the glass type, which comprises a coating that contains at least one layer C based on silicon or aluminum [nitride, carbonitride, oxynitride or oxycarbonitride] or on a mixture of the two, which is surmounted by a cover layer, characterized in that the cover layer is an oxide-based mechanical protection layer, this oxide being optionally oxygen-substoichiometric or oxygen-superstoichiometric and/or optionally nitrided.

2. The substrate as claimed in claim 1, characterized in that the protective oxide layer advantageously contains at least one element chosen from Ti, Zn, Sn, Al, Ga, In, B, Y, La, Ge, Si, P, As, Sb, Bi, Ce, Ti, Zr, Nb, Ta and Hf.

3. The substrate as claimed in claim 1 or 2, characterized in that the protective layer contains at least one optionally nitrided titanium oxide.

4. The substrate as claimed in the preceding claim, characterized in that said titanium oxide contains another metal M, such as aluminum (compounds of formula TiMₚOₓN_{y} where p and y may be zero).

5. The substrate as claimed in claim 3 or 4, characterized in that the titanium oxide is chosen from TiO₂, TiOₓ where 1≦x≦2, or TiOₓN_{y} where 1≦x≦2 and 0.5≦y≦1.

6. The substrate as claimed in any one of the preceding claims, characterized in that the protective layer includes at least one oxide containing at least zinc and optionally at least one other element, optionally doped by at least one other element chosen from Al, Ga, In, B, Y, La, Ge, Si, P, As, Sb, Ce, Ti, Zr, Nb, Hf and Ta, this oxide being optionally oxygen-substoichiometric or oxygen-superstoichiometric and/or optionally nitrided.

7. The substrate as claimed in the preceding claim, characterized in that the oxide is a mixed oxide based on zinc and another metal, especially one based on zinc and tin (ZnSnOₓ) or on zinc and titanium (ZnTiOₓ) or on zinc and zirconium (ZnZrOₓ).

8. The substrate as claimed in the preceding claim, characterized in that the zinc-based mixed oxide is doped by at least one other element chosen from Al, Ga, In, B, Y, La, Ge, Si, P, As, Sb, Ce, Ti, Zr, Nb, Hf and Ta.

9. The substrate as claimed in any one of the preceding claims, characterized in that the protective layer includes at least one oxide containing at least zirconium, especially a Zr-based mixed oxide, optionally including another metal, this oxide being optionally oxygen-substoichiometric or oxygen-superstoichiometric and/or optionally nitrided.

10. The substrate as claimed in the preceding claim, characterized in that the oxide containing at least zirconium is doped by at least one other element chosen from Al, Ga, In, B, Y, La, Ge, Si, P, As, Sb, Ce, Ti, Zn, Nb, Hf and Ta.

11. The substrate as claimed in any one of the preceding claims, characterized in that the mechanical protection cover layer is made up from a superposition of oxide layers, such as especially a combination of ZnO/TiO₂, ZnᵣSnₛSbₜOₓ/TiO₂, ZnᵣSnₛAlᵤOₓ/TiO₂ and ZnᵣZrᵥOₓ/TiO₂ layers.

12. The substrate as claimed in any one of the preceding claims, characterized in that the oxide layer has a thickness of around 15 nm or less, preferably less than or equal to 10 nm.

13. The substrate as claimed in any one of the preceding claims, characterized in that the layer(s) C may furthermore contain at least one other metallic element such as aluminum.

14. The substrate as claimed in any one of the preceding claims, characterized in that the or each layer C has a thickness of around 5 to 60 nm.

15. The substrate as claimed in any one of the preceding claims, characterized in that the coating has an antireflection function or a solar-control function or an energy-control function of the low-emissivity type using at least one functional layer, especially a metallic layer, which reflects some of the radiation of the solar spectrum.

16. The substrate as claimed in any one of the preceding claims, characterized in that it includes at least one metallic or metal-nitride-based functional layer.

17. The substrate as claimed in any one of the preceding claims, characterized in that the coating includes the dielectric final sequence: oxide/silicon nitride/oxide, especially ZnO/Si₃N₄/ZnO.

18. The substrate as claimed in any one of the preceding claims, characterized in that the multilayer has the following sequence:
Si₃N₄/ZnO/Ag/ZnO/Si₃N₄/cover layer
or Si₃N₄/ZnO/Ag/ZnO/Si₃N₄/ZnO/Ag/ZnO/Si₃N₄/cover layer
optionally with a metal blocking layer in contact with at least one of the silver layers.

19. The substrate as claimed in any one of claims 15 to 18, characterized in that the coating substantially preserves its properties, especially its optical properties, after a heat treatment.

20. A glazing assembly incorporating at least one substrate as claimed in any one of the preceding claims, especially in a multiple glazing or laminated glazing configuration.

21. A process for improving the mechanical resistance of a transparent substrate, especially a glass substrate, which comprises a multilayer that includes at least one dielectric layer C based on a silicon or aluminum [nitride, carbonitride, oxynitride or oxycarbonitride] or on a mixture of the two, characterized in that an oxide-based layer is deposited on at least one dielectric layer C, this oxide optionally being oxygen-substoichiometric or oxygen-superstoichiometric and/or optionally nitrided.

22. The use of an oxide-based coating, this oxide optionally being oxygen-substoichiometric and/or optionally nitrided, in order to improve the mechanical resistance of a transparent substrate, especially a glass substrate, which comprises a multilayer coating that includes at least one layer C based on a silicon or aluminum [nitride, carbonitride, oxynitride or oxycarbonitride] or on a mixture of the two.
